(19) United States
(12) Patent Application Publication
(10) Pub. No.: US 2016/0377962 A1
(43) Pub. Date: Dec. 29, 2016

(54) OPTICAL DEVICE AND IMAGE DISPLAY APPARATUS

(71) Applicant: Seiko Epson Corporation, Tokyo (JP)

(72) Inventor: Yasushi MIZOGUCHI, Suwa (JP)

(21) Appl. No.: 15/185,442

(22) Filed: Jun. 17, 2016

(30) Foreign Application Priority Data
Jun. 29, 2015 (JP) 2015-129589

(51) Int. Cl. G03B 21/14; G03B 21/16; G02B 27/01; G09G 3/00

(52) U.S. Cl. CPC G03B 21/142; G09G 3/007; G03B 21/16; G02B 27/0172; G02B 2027/0147

(57) ABSTRACT

An optical device includes a glass plate, a movable section that supports the glass plate, shaft sections that swingably support the movable section around a swing axis, a support section that supports the shaft sections, a permanent magnet provided in the movable section, a coil that is so disposed as to face the permanent magnet and produces a magnetic field acting on the permanent magnet, and a coil support section that is supported by the support section and supports the coil, and the coil support section is made of a material having thermal conductivity higher than that of the support section and intersects the in-plane direction of a light incident surface.

### BACKGROUND

1. Technical Field

The present invention relates to an optical device and an image display apparatus.

2. Related Art

As described in JP-A-2011-203460, to achieve higher resolution of a projected image than the resolution of a light modulator, such as a liquid crystal panel, there has been a known technology of related art for shifting the axis of video image light outputted from the light modulator. In JP-A-2011-203460, a wobbling device including a light transmissive plate and a driver (piezoelectric element) that causes the light transmissive plate to swing is used as a device for shifting the axis of video image light.

JP-A-2011-203460, however, does not disclose the configuration of the wobbling device in detail. It is, for example, conceivable that heat generated by the driver of the wobbling device changes vibration characteristics of the wobbling device and the wobbling device cannot show stable vibration characteristics.

### SUMMARY

An advantage of some aspects of the invention is to provide an optical device which is less affected by heat and capable of showing stable vibration characteristics and an image display apparatus including the optical device.

The advantage can be achieved by the invention described below.

An optical device according to an aspect of the invention includes an optical section having a light incident surface on which light is incident, a movable section that supports the optical section, a shaft section that swingably supports the movable section around a swing axis, a support section that supports the shaft section, a permanent magnet provided in the movable section, a coil that produces a magnetic field acting on the permanent magnet, and a coil support section that supports the coil, and the coil support section is made of a material having thermal conductivity higher than thermal conductivity of the support section and intersects an in-plane direction of the light incident surface.

Heat generated by the coil when current flows therethrough can therefore be efficiently dissipated through the coil support section before the heat is transmitted to the support section. As a result, stable vibration characteristics are achieved. Further, since the coil support section intersects the in-plane direction of the light incident surface, an increase in the size of the optical device can be reduced.

In the optical device according to the aspect of the invention, it is preferable that the coil support section is disposed along a surface of the coil that is a side surface formed in a direction that intersects the in-plane direction of the light incident surface.

With this configuration, the size of the coil support section can be reduced.

In the optical device according to the aspect of the invention, it is preferable that the coil has an elongated shape in a plan view in a thickness direction of the optical section, and that the coil support section is disposed along the elongated direction of the coil and along the side surface formed in the direction that intersects the in-plane direction of the light incident surface.

With this configuration, as compared, for example, with a case where the portion that intersects the in-plane direction of the light incident surface is disposed along a side surface extending along the short-side direction of the coil, the area of the intersecting portion can be increased. The heat generated by the coil can therefore be more effectively dissipated.

In the optical device according to the aspect of the invention, it is preferable that the coil support section includes a first support section that supports the coil and is provided along the in-plane direction of the light incident surface, and a second support section that intersects the first support section and supports a surface of the coil that is a side surface formed in a direction that intersects the in-plane direction of the light incident surface.

With this configuration, the area where the coil support section is in contact with the coil increases, whereby the heat from the coil can be more effectively dissipated. Further, causing the coil to come into contact with the first support section and the second support section allows the coil to be positioned in a simple, precise manner.

In the optical device according to the aspect of the invention, it is preferable that the coil is so disposed as to face the permanent magnet, and that the coil is so located that a surface thereof facing the permanent magnet is closer than the second support section to the permanent magnet in a plan view in which the second support section is viewed in a direction parallel to the light incident surface.

With this configuration, the gap between the coil and the permanent magnet can be readily adjusted.

In the optical device according to the aspect of the invention, it is preferable that the support section has a window through which a clearance between the permanent magnet and the coil is visible.

With this configuration, the coil can be positioned with respect to the permanent magnet with precision.

In the optical device according to the aspect of the invention, it is preferable that the window is a through hole.

With this configuration, the configuration of the window is simplified. Further, for example, since cooling air is allowed to impinge on the coil support section through the window, the heat generated by the coil can be more effectively dissipated.

It is preferable that the optical device according to the aspect of the invention further includes an enclosure that supports the support section, and the coil support section is supported by the enclosure.

With this configuration, the heat generated by the coil is unlikely to be transmitted to the support section.

In the optical device according to the aspect of the invention, it is preferable that the coil support section is so disposed as to be separate from the support section.

With this configuration, the heat in the coil support section is unlikely to be transmitted to the support section.

In the optical device according to the aspect of the invention, it is preferable that the optical section transmits the light.

With this configuration, the optical axis of the light can be shifted by using refraction in the optical section.

An image display apparatus according to another aspect of the invention includes the optical device according to the aspect of the invention.

With this configuration, an image display apparatus having excellent display characteristics is provided.

It is preferable that the image display apparatus according to the aspect of the invention is so configured that the optical device refracts the light to shift positions of pixels displayed when irradiated with the light.

With this configuration, the resolution can be spuriously increased.

### BRIEF DESCRIPTION OF THE DRAWINGS

The invention will be described with reference to the accompanying drawings, wherein like numbers reference like elements.

FIG. 1 shows an optical configuration of an image display apparatus according a first embodiment of the invention.

FIG. 2 shows a state in which video image light is shifted.

FIG. 3 is a block diagram showing an electrical configuration of the image display apparatus shown in FIG. 1.

FIGS. 4A and 4B are perspective views of an optical device provided in the image display apparatus shown in FIG. 1.

FIG. 5 is a cross-sectional view taken along the line A-A in FIG. 4A.

FIG. 6 is a plan view showing a drive mechanism provided in the optical device shown in FIGS. 4A and 4B.

FIG. 7 is a perspective view of a coil support section provided in the optical device shown in FIGS. 4A and 4B.

FIG. 8 is a cross-sectional view of the coil support section shown in FIG. 7.

FIG. 9 is another cross-sectional view of the coil support section shown in FIG. 7.

FIG. 10 is a plan view showing an optical device provided in an image display apparatus according to a second embodiment of the invention.

FIG. 11 is a cross-sectional view of the optical device shown in FIG. 10.

FIG. 12 is a perspective view showing a holding member provided in the image display apparatus.

FIG. 13 is a cross-sectional view of the holding member shown in FIG. 12.

FIG. 14 shows an optical configuration of an image display apparatus according to a third embodiment of the invention.

FIG. 15 shows an optical configuration of an image display apparatus according to a fourth embodiment of the invention.

### DESCRIPTION OF EXEMPLARY EMBODIMENTS

An optical device and an image display apparatus according to each embodiment of the invention will be described below in detail with reference to the accompanying drawings.

### First Embodiment

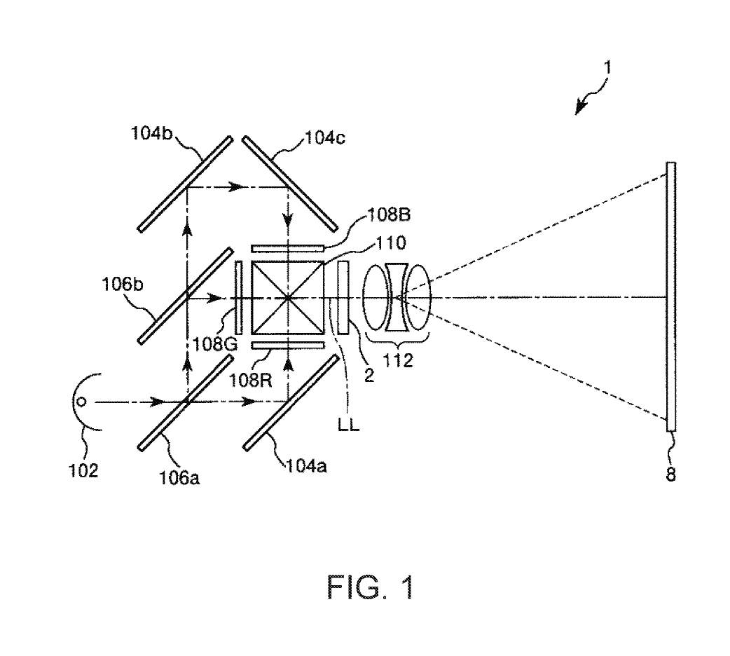

FIG. 1 shows an optical configuration of an image display apparatus according a first embodiment of the invention.

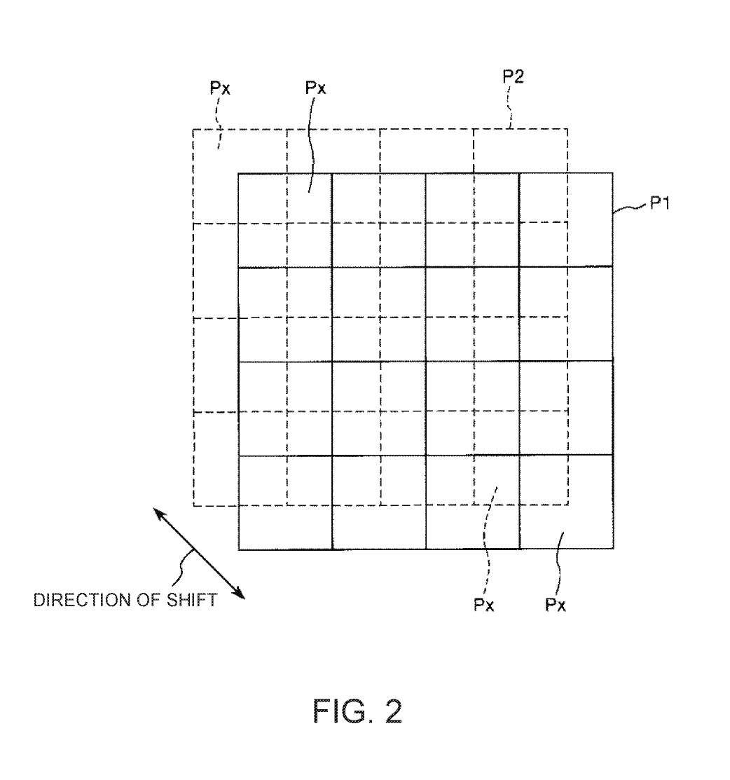

FIG. 2 shows a state in which video image light is shifted.

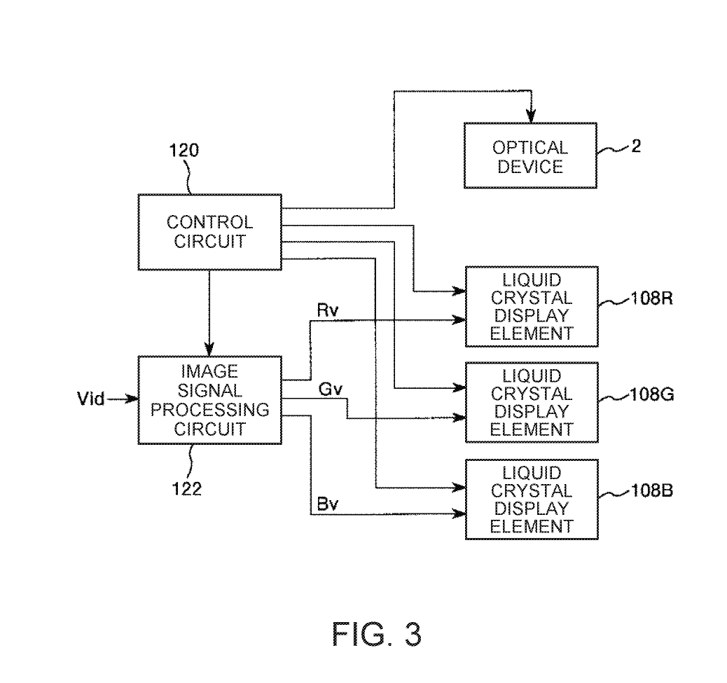

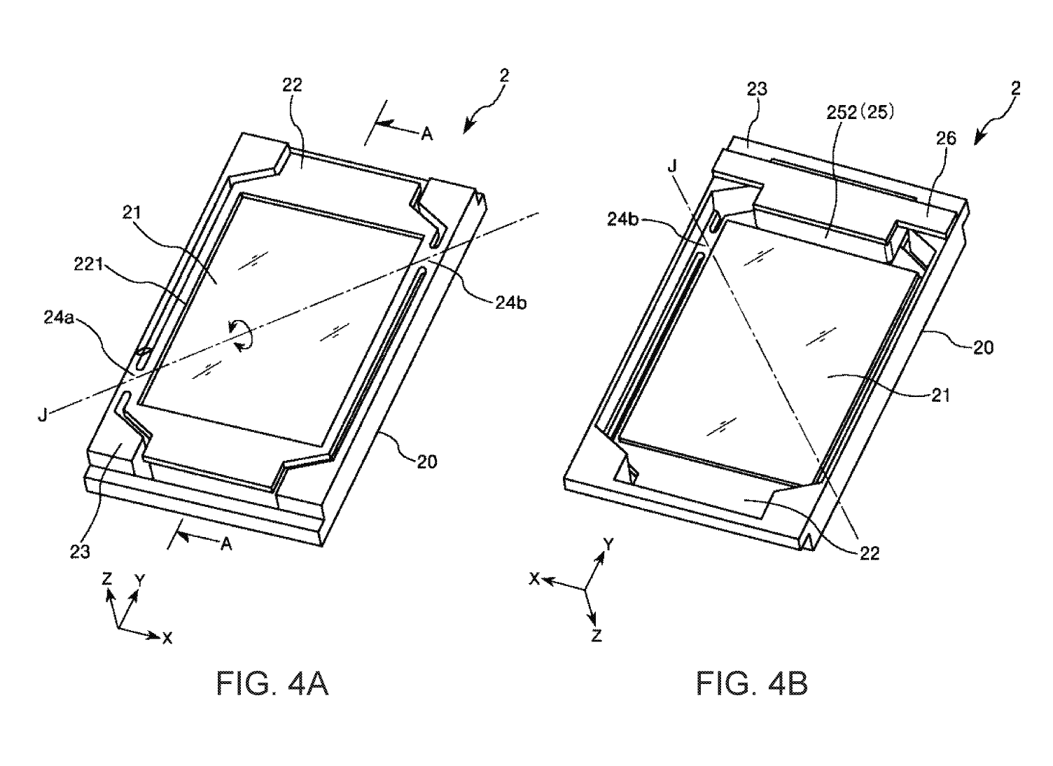

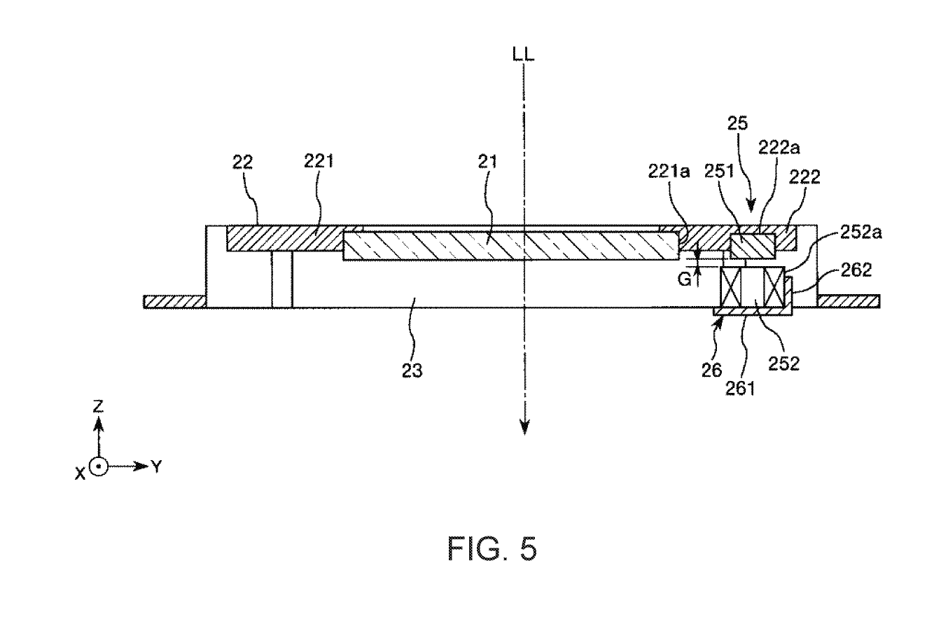

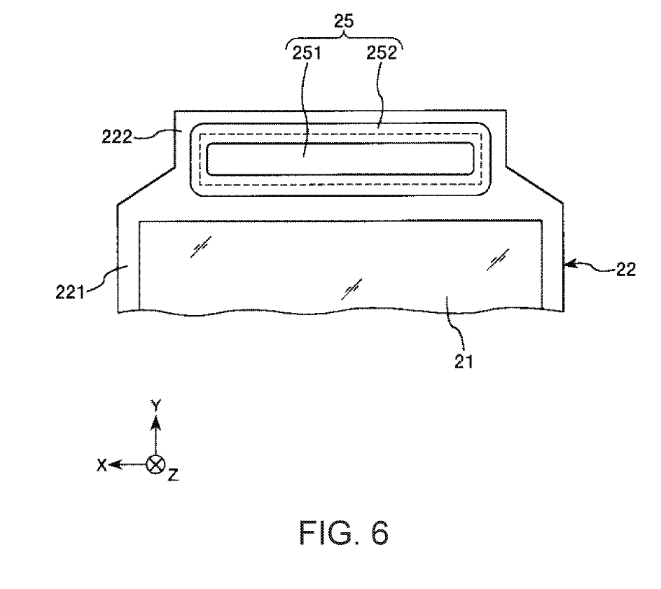

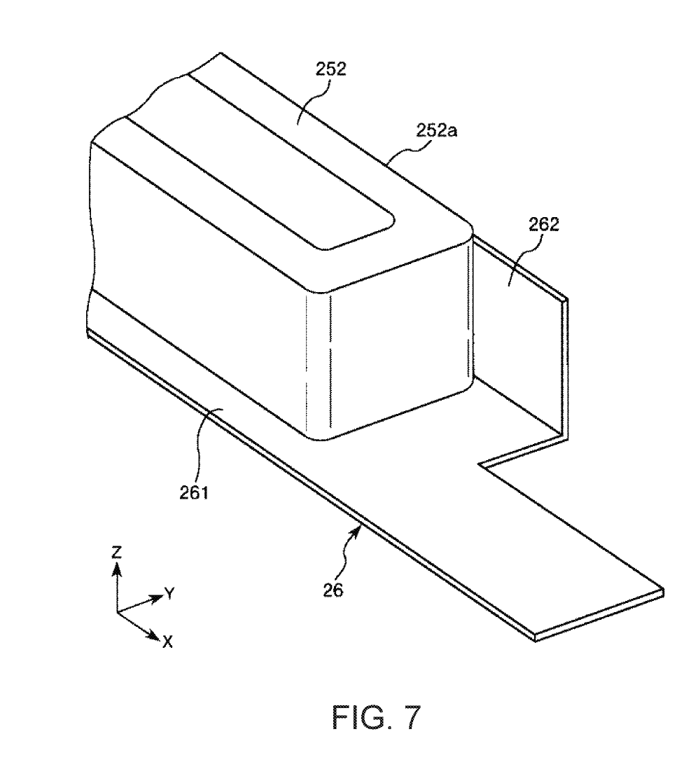

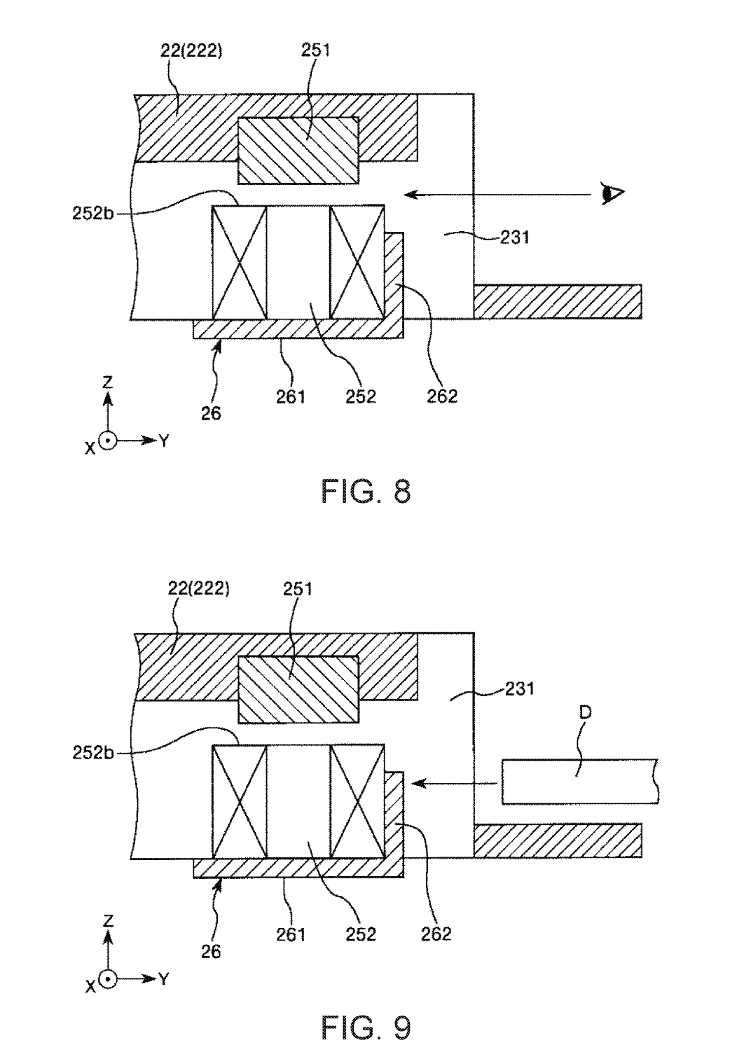

FIG. 3 is a block diagram showing an electrical configuration of the image display apparatus shown in FIG. 1. FIGS. 4A and 4B are perspective views of an optical device provided in the image display apparatus shown in FIG. 1. FIG. 5 is a cross-sectional view taken along the line A-A in FIG. 4A. FIG. 6 is a plan view showing a drive mechanism provided in the optical device shown in FIGS. 4A and 4B. FIG. 7 is a perspective view of a coil support section provided in the optical device shown in FIGS. 4A and 4B. FIGS. 8 and 9 are cross-sectional views of the coil support section shown in FIG. 7. In FIGS. 4A and 4B to FIG. 9, an X axis, a Y axis, and a Z axis are shown as three axes perpendicular to each other for ease of description. Further, in the following description, the direction parallel to the X axis is also called an “X-axis direction,” the direction parallel to the Y axis is also called a “Y-axis direction,” and the direction parallel to the Z axis is also called a “Z-axis direction.”

### Projector

A projector (image display apparatus) 1 shown in FIG. 1 is an LCD-based projector and includes a light source 102, mirrors 104a, 104b, and 104c, dichroic mirrors 106a and 106b, liquid crystal display elements 108R, 108G, and 108B, a dichroic prism 110, an optical device 2 as an optical path deflector, and a projection lens system 112, as shown in FIG. 1.

Examples of the light source 102 may include a halogen lamp, a mercury lamp, and a light emitting diode (LED) . As the light source 102, a light source emitting white light is used. Light emitted from the light source 102 is first separated by the dichroic mirror 106a into red light (R) and light of other colors. The red light is reflected off the mirror 104a and then incident on the liquid crystal display element 108R, and the light of other colors is further separated by the dichroic mirror 106b into green light (G) and blue light (B). The green light is incident on the liquid crystal display element 108G, and the blue light is reflected off the mirrors 104b and 104c and then incident on the liquid crystal display element 108B.

Each of the liquid crystal display elements 108R, 108G, and 108B is used as a spatial light modulator. The liquid crystal display elements 108R, 108G, and 108B are transmissive spatial light modulators corresponding to the RGB primary colors and each have pixels arranged in a matrix, for example, having 1080 vertical columns and 1920 horizontal rows. Each of the pixels adjusts the amount of transmitted light out of incident light, so that the distribution of the amount of light over the entire pixels in each of the liquid crystal display elements 108R, 108G, and 108B is controlled in a coordinated manner. Light fluxes spatially modulated by the thus configured liquid crystal display elements 108R, 108G, and 108B are combined by the dichroic prism 110 with one another, and full-color video image light LL is outputted from the dichroic prism 110. The outputted video image light LL is then enlarged and projected by the projection lens system 112 on a screen 8.

The projector 1 has the optical device 2 between the dichroic prism 110 and the projection lens system 112, and the optical device 2 shifts the optical axis of the video image light LL (performs what is called “pixel shift”) to allow an image having resolution higher than the resolution of the liquid crystal display elements 108R, 108G, and 108B (4K-resolution image in a case where each of the liquid crystal display elements 108R, 108G, and 108B is a full-high-vision element) to be projected on the screen 8. The principle of the high-resolution image formation will be briefly described with reference to FIG. 2. The optical device 2 has a glass plate 21, which transmits the video image light LL, and changing the posture of the glass plate 21 allows the optical axis of the video image light LL to be shifted on the basis of refraction.

Using the shift of the optical axis, the projector 1 is configured to cause an image display position P1 in a case where the optical axis of the video image light LL is shifted toward one side and an image display position P2 in a case where the optical axis of the video image light LL is shifted toward the other side to be shifted from each other in an oblique direction (direction indicated by the arrow in FIG. 2) on the screen 8 by the amount corresponding to half a pixel (that is, half a pixel Px), and displaying images alternately in the image display positions P1 and P2 increases the apparent number of pixels, whereby the resolution of the images projected on the screen 8 is increased. The amount of shift between the image display positions P1 and P2 is not limited to the amount corresponding to half a pixel and may be the amount corresponding to ¼ of the pixel Px or ¾ of the pixel Px.

The thus configured projector 1 includes a control circuit 120 and an image signal processing circuit 122 as well as the optical device 2 and the liquid crystal display elements 108R, 108G, and 108B, as shown in FIG. 3. The control circuit 120 controls action of writing a data signal to each of the liquid crystal display elements 108R, 108G, and 108B, action of optical path deflection in the optical device 2, action of generating the data signal in the image signal processing circuit 122, and other types of action. On the other hand, the image signal processing circuit 122 separates an image signal Vid supplied from an external apparatus that is not shown into signals corresponding to the RGB three primary colors and converts the separated signals into data signals Rv, Gv, and By suitable for the action of the liquid crystal display elements 108R, 108G, and 108B. The converted data signals Rv, Gv, and By are then supplied to the liquid crystal display elements 108R, 108G, and 108B, respectively, and the liquid crystal display elements 108R, 108G, and 108B operate on the basis of the received signals.

### Optical Device

The optical device 2 incorporated in the projector 1 described above will next be described in detail.

The optical device 2 includes a structural body 20 having a movable section 22, which is provided with the glass plate (optical section) 21, which has light transmissivity and deflects the video image light LL, a frame-shaped support section 23, which is so provided to surround the movable section 22, and shaft sections 24a and 24b, which connect the movable section 22 and the support section 23 to each other and so supports the movable section 22 as to be swingable (pivotable) around a swing axis J relative to the support section 23; a drive mechanism 25, which causes the movable section 22 to swing relative to the support section 23; and a coil support section 26, which supports a coil 252 provided in the drive mechanism 25, as shown in FIGS. 4A and 4B. The thus configured optical device 2 is, for example, so disposed in the projector 1 that the +Z side of the optical device 2 faces the dichroic prism 110 and the −Z side of the optical device 2 faces the projection lens system 112. The orientation of the optical device 2 may instead be reversed.

The movable section 22 has a flat-plate-like shape and has a glass plate support section 221, which supports the glass plate 21, and a permanent magnet support section 222, which is provided outside the glass plate support section 221 and supports a permanent magnet 251 provided in the drive mechanism 25, as shown in FIG. 5. The glass plate support section 221 has a through hole 221a provided in a central portion thereof, and the glass plate 21 is fit into the through hole 221a. The glass plate 21 is bonded to the glass plate support section 221, for example, with an adhesive that is not shown.

The glass plate 21 supported by the thus configured glass plate support section has a rectangular shape in a plan view. The glass plate 21 has light transmissivity and has one principal surface that forms a light incident portion on which light is incident and the other principal surface that forms a light exiting surface through which light exits. The thus configured glass plate 21 allows the video image light LL incident thereon to be refracted and transmitted when the video image light LL is incident on the glass plate 21 at an oblique angle of incidence that is not 0°. Therefore, changing the posture of the glass plate 21 in such a way that a target angle of incidence is achieved allows the direction and the amount of deflected video image light LL to be controlled. The glass plate 21 is so sized as appropriate to be capable of transmitting the entire video image light LL outputted from the dichroic prism 110. Further, it is preferable that the glass plate 21 is substantially colorless and transparent. Antireflection films may be formed on the light incident surface of the glass plate 21 on which the video image light LL is incident and the light exiting surface of the glass plate 21 through which the video image light LL exits.

The material of which the glass plate 21 is made is not limited to a specific material and can be, for example, any of a variety of glass materials, such as white sheet glass, borosilicate glass, and quartz glass. In the present embodiment, the glass plate 21 is used as the optical section, but the optical section is not necessarily made of a glass material and may be made of any material having light transmissivity and made of a material that can refract the video image light LL. For example, the optical section may be made of any of a variety of crystal materials, such as quartz and sapphire, or a variety of resin materials, such as a polycarbonate-based resin and an acrylic resin. It is, however, noted that the optical section is preferably formed of the glass plate 21, as in the present embodiment, which allows the rigidity of the optical section to be particularly increased, whereby unevenness in deflection of the video image light LL deflected by the optical section can be particularly suppressed.

The permanent magnet support section 222, in which the permanent magnet 251 is disposed, is provided along the outer circumference of the glass plate support section 221, which supports the glass plate 21. The permanent magnet support section 222 is so disposed as to be shifted from the swing axis J. The thus disposed permanent magnet support section 222 is provided with a recessed section 222a, and the permanent magnet 251 is fit into the recessed section 222a. The thus fit permanent magnet 251 is bonded (fixed) to the recessed section 222a, for example, with an adhesive that is not shown.

The frame-shaped support section 23 is provided around the thus configured movable section 22, and the movable section 22 and the support section 23 are connected to each other via the shafts sections 24a and 24b. The shafts sections 24a and 24b are shifted from each other in the X-axis and Y-axis directions in a plan view, and the swing axis J is therefore so formed as to be inclined to the X-axis and Y-axis directions by about 45°. The movable section 22 swings around the thus formed swing axis J, and the swing motion changes the posture of the glass plate 21. In particular, in the optical device 2, the shafts sections 24a and 24b are disposed symmetrically with respect to the center of the glass plate 21 in a plan view, whereby the movable section 22 is swingable in a well-balanced manner. The inclination angle of the swing axis J to the X axis (Y axis) is not limited to 45°.

The structural body 20 described above (movable section 22, support section 23, and shafts sections 24a and 24b) is formed as a monolithic part. The monolithic structure can increase impact resistance and durability of the boundary portion between the support section 23 and the shafts sections 24a, 24b and the boundary portion between the shafts sections 24a, 24b and the movable section 22.

The structural body 20 (movable section 22, support section 23, and shafts sections 24a and 24b) is made of a material having Young's modulus smaller than that of the material of which the glass plate 21 is made. The material of the structural body 20 preferably contains a resin and more preferably contains a resin as a primarily component. A resin-containing material can effectively prevent stress induced in the structural body 20 in response to the swing motion of the movable section 22 from causing unnecessary vibration of the glass plate 21 itself. Further, the configuration in which the soft movable section 22 surrounds the side surface of the glass plate 21 (surface formed along thickness direction of glass plate 21) can suppress stress induced in the glass plate 21 when the posture of the glass plate 21 is changed, whereby unnecessary vibration of the glass plate 21 that occurs in accordance with the stress distribution can be suppressed. As a result, a situation in which an image is deflected by the glass plate 21 in an unintended direction can be avoided. Further, a change in the swing path of the movable section 22 due to a change in environment temperature can be suppressed. Moreover, for example, the shafts sections 24a and 24b and portions therearound can be sufficiently softened, and the optical device 2 can be compact and have a low resonant frequency (for example, about 130 to 170 Hz).

The resin described above is not limited to a specific resin and may be, for example, polyethylene, polypropylene, silicone, polyacetal, polyamide, polycarbonate, polyphenylene ether, polyethylene terephthalate, polybutylene terephthalate, polyarylate, polysulphone, polyethersulphone, polyphenylenesulfide, polyetheretherketone, polyimide, polyetherimide, and fluororesin. A material containing at least one of the resins described above is used.

The drive mechanism 25, which causes the movable section 22 to swing, will next be described. The drive mechanism 25 is an electromagnetic actuator including the permanent magnet 251, which is disposed in the permanent magnet support section 222, and the coil 252, which is so disposed to face the permanent magnet 251 and generates a magnetic field acting on the permanent magnet 251, as shown in FIG. 5. Using the electromagnetic actuator having the simple configuration as the drive mechanism 25 allows generation of force strong enough to cause the movable section 22 to swing, whereby the movable section 22 is allowed to swing smoothly.

The permanent magnet 251 has an elongated shape in the X-axis direction, as shown in FIG. 6, and is magnetized in the Z-axis direction. In other words, the permanent magnet 251 has an oblong shape when viewed in the plate thickness direction of the glass plate 21 and is magnetized in the Z-axis direction. The permanent magnet 251, which extends in the X-axis direction, is allowed to be disposed in a position shifted toward the center of the movable section 22, whereby the moment of inertia of the movable section 22 can be lowered. The movable section 22 is therefore allowed to swing more smoothly. The permanent magnet 251 is not limited to a specific magnet and may be, for example, a neodymium magnet, a ferrite magnet, a samarium-cobalt magnet, and an alnico magnet.

On the other hand, the coil 252 is so disposed as to face the permanent magnet 251. The coil 252 has an elongated shape extending in the X-axis direction in correspondence with the permanent magnet 251. In other words, the coil 252 has an oblong shape when viewed in the plate thickness direction of the glass plate 21. The coil 252 is an air core coil. Using an air core coil as the coil 252 allows the movable section 22 to swing more smoothly. Specifically, when the coil 252 has a core, for example, the permanent magnet 251 may undesirably be attracted toward the core depending on the strength of the magnetic force generated by the coil, resulting in displacement of the swing axis J and unsmooth swing motion of the movable section 22 in some cases. To prevent such a problem from occurring, it is preferable to use an air core coil as the coil 252, as in the present embodiment.

In the thus configured drive mechanism 25, when a voltage application section that is not shown applies a drive signal to the coil 252, the coil 252 produces a magnetic field, and the produced magnetic field acts on the permanent magnet 251, whereby the movable section 22 swings (pivots) around the swing axis J relative to the support section 23. The swing motion of the movable section 22 so shifts the optical axis of the video image light LL that images are alternately displayed in the image display positions P1 and P2. The apparent number of pixels therefore increases, whereby the resolution of the images is increased.

In particular, in the drive mechanism 25, the outer circumference (contour) of the permanent magnet 251 is greater than the inner circumference of the coil 252 but smaller than the outer circumference of the coil 252 in a plan view viewed in the Z-axis direction, as shown in FIG. 6. The thus designed permanent magnet 251 and coil 252 allow reduction in the size of the coil 252, whereby electric power loss (such as heat generation) that occurs when current is caused to flow through the coil 252 can be suppressed, and the coil 252 can produce a magnetic field in a more efficient, power-saving manner. Further, the magnetic field produced by the coil 252 is allowed to efficiently act on the permanent magnet 251.

The configuration of the drive mechanism 25 is not limited to a specific configuration and may be any configuration that allows the movable section 22 to swing. For example, in the present embodiment, the drive mechanism 25 is provided only on one side of the swing axis J, but the drive mechanism 25 may instead be provided on both sides of the swing axis J. This configuration allows the movable section 22 to swing in a further well-balanced manner.

The separation distance (gap G) between coil 252 and the permanent magnet 251 is not limited to a specific value and is, for example, preferably greater than or equal to about 0.1 mm but smaller than or equal to about 0.5 mm, more preferably greater than or equal to about 0.2 mm but smaller than or equal to about 0.4 mm, although the separation distance depends on the size of the movable section 22, the magnitude of the magnetic field produced by the coil 252, and other factors. The thus set separation distance prevents the permanent magnet 251 and the coil 252 from coming into contact with each other when the movable section 22 swings and allows the magnetic field produced by the coil 252 to act on the permanent magnet 251 in a more efficient manner. The movable section 22 is therefore allowed to swing in a more efficient, stable manner.

The coil 252 provided in the drive mechanism 25 is supported by the coil support section 26, which is fixed to the support section 23, and the coil 252 is in turn supported by the support section 23. The coil 252 is not necessarily fixed to the coil support section 26 in a specific manner and can be fixed thereto, for example, with an adhesive.

When the configuration in which the coil 252 is fixed to the support section 23 via the coil support section 26 is employed as described above, the position of the coil 252 with respect to the permanent magnet 251 can be adjusted by adjustment of the position where the coil support section 26 is fixed to the support section 23. The positional relationship between the permanent magnet 251 and the coil 252 can therefore be readily adjusted. The coil support section 26 is not necessarily fixed to the support section 23 in a specific manner, and an adhesive, screw fastening, and protrusion-depression fitting can, for example, be used.

The thus configured coil support section 26 supports the coil 252 on the side thereof opposite the permanent magnet 251. That is, the coil support section 26 is so provided not to be present between the permanent magnet 251 and the coil 252. The arrangement of the coil support section 26 allows a smaller gap G between the permanent magnet 251 and the coil 252.

Further, the coil support section 26 is bent in a halfway position thereof at roughly right angles and therefore has a roughly L-letter-like cross-sectional shape, as shown in FIGS. 5 and 7. Specifically, the coil support section 26 has a first support section 261, which is fixed to the support section 23, and a second support section 262, which is connected to the first support section 261 and bent at roughly right angles with respect to the first support section 261. The first support section 261 has a plate-like shape that extends along an XY plane and has a thickness in the Z-axis direction, and the second support section 262 has a plate-like shape that extends along an XZ plane and has a thickness in the Y-axis direction. The thus configured coil support section 26 is made of a material having thermal conductivity higher than that of the support section 23.

The coil support section 26, which is formed of the first support section 261 and the second support section 262, has a large surface area. Further, the coil support section 26, which is made of a material having thermal conductivity higher than that of the support section 23, can effectively dissipate heat generated by the coil 252 when current flows therethrough. Therefore, the heat generated by the coil 252 is unlikely to be transmitted to the support section 23 (structural body 20), and changes in the vibration characteristics of the optical device 2 that result from thermal expansion of the structural body 20, softened shafts sections 24a and 24b due to the heat, and other factors are suppressed, whereby stable vibration characteristics are achieved. Further, since the amount of heat generated by the coil 252 can also be reduced, electric power loss due to the heat generated by the coil 252 can be suppressed. The coil 252 is therefore allowed to produce a magnetic field in a more efficient (power-saving) manner.

In particular, since the second support section 262 intersects the in-plane direction (in-XY-plane direction) of the light incident surface of the glass plate 21, that is, since the second support section 262 is bent relative to the first support section 261, the area of the coil support section 26 when viewed in the Z-axis direction can be reduced, whereby the size of the optical device 2 can also be reduced.

The coil support section 26 is preferably made of a nonmagnetic material. In this case, a situation in which the coil support section 26 is attracted by the magnetic field produced by the permanent magnet 251 can be avoided.

Examples of the material of which the coil support section 26 is made (not only material having thermal conductivity higher than that of the material of the support section 23 but also material that is nonmagnetic) may include aluminum, copper, silver, and nonmagnetic stainless steel.

The thus configured coil support section 26 is so disposed that the first support section 261 is disposed along the bottom surface of the coil 252 (surface opposite the surface facing permanent magnet 251) and the second support section 262 is disposed along the side surface of the coil 252 (surface so formed as to intersect glass plate 21 in plan view of glass plate 21). In other words, the first support section 261 is provided along the in-plane direction of the light incident surface of the glass plate 21 (plane extended from light incident surface of glass plate 21 or direction definable in extended plane), and the second support section 262 extends in a direction that intersects the in-plane direction of the light incident surface of the glass plate 21 in a plan view of the glass plate 21. The state in which an object intersects the in-plane direction refers, for example, to a state in which the object so extends or is so formed as to intersect a surface extended from the light incident surface of the glass plate 21 or a direction definable in the extended plane.

The thus configured coil support section 26 has a large area in contact with the coil 252, whereby the heat generated by the coil 252 can be efficiently dissipated through the coil support section 26. In particular, in the present embodiment, the second support section 262 is disposed along a side surface 252a extending in the elongated direction of the coil 252. The area of the second support section 262 (in other words, area in contact with coil 252) can therefore be increased, as compared with a case where the second support section 262 is disposed along the side surface extending in the short-side direction, whereby the heat can be more effectively dissipated through the coil support section 26.

Further, when the coil 252 is so disposed as to come into contact with the first support section 261 and the second support section 262, as in the present embodiment, the coil 252 can be readily positioned with respect to the coil support section 26 with precision. The coil 252 may be in direct contact with the first and second support section 261, 262 or may be in indirect contact therewith, for example, via an adhesive.

Further, in the present embodiment, the coil 252 is so located that a surface 252b thereof facing the permanent magnet 251 is closer than the second support section 262 to the permanent magnet 251, as shown in FIG. 8. In other words, the coil 252 is so provided as to protrude from the second support section 262 toward the permanent magnet 251 in a plan view in which the second support section 262 is viewed in the in-plane direction of the light incident surface. In still other words, the coil 252 is so disposed that the coil 252 faces (oppose) the permanent magnet 251 and that the surface facing the permanent magnet 251 is closer than the second support section 262 to the permanent magnet 251 in a plan view in which the second support section 262 is viewed in the direction parallel to the light incident surface. The configuration described above allows the clearance (gap G) between the permanent magnet 251 and the coil 252 to be visible when viewed in the Y-axis direction, whereby the gap G can be adjusted with precision. The arrangement of the coil 252 is not limited to the arrangement described above. For example, the surface 252b facing the permanent magnet 251 may flush with the permanent-magnet-side end of the second support section 262 in a plan view of the second support section 262.

In particular, in the optical device 2 of the present embodiment, the support section 23 is provided with a window 231, through which the clearance between the permanent magnet 251 and the coil 252 is visible when viewed in the Y-axis direction from a position outside the optical device 2. The clearance (gap G) between the permanent magnet 251 and the coil 252 can therefore be more readily visually recognized. The configuration of the window 231 is not limited to a specific configuration as long as the clearance is visible but is preferably formed of a through hole, as in the present embodiment. The configuration of the window 231 is simplified in this case. Further, for example, when a cooling duct D is disposed in the vicinity of the window 231, as shown in FIG. 9, cooling air supplied through the duct D can be sprayed on the coil support section 26 (second support section 262) through the window 231. The heat dissipation effect of the coil support section 26 can therefore be enhanced. Further, when the cooling air is sprayed through the window 231, the cooling air is unlikely to impinge on the movable section 22, whereby the vibration characteristics of the movable section 22 are unlikely to be affected by the cooling air. The cooling air can be cooling air produced by a cooler built in the projector 1 to cool the portions of the projector 1 (light source 102, for example).

### Second Embodiment

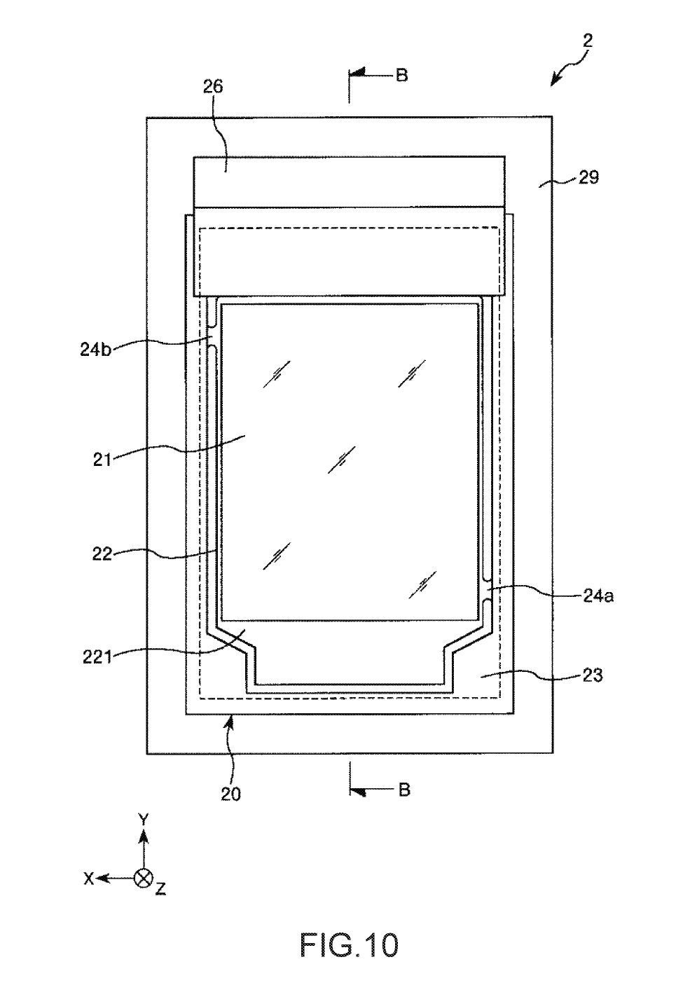

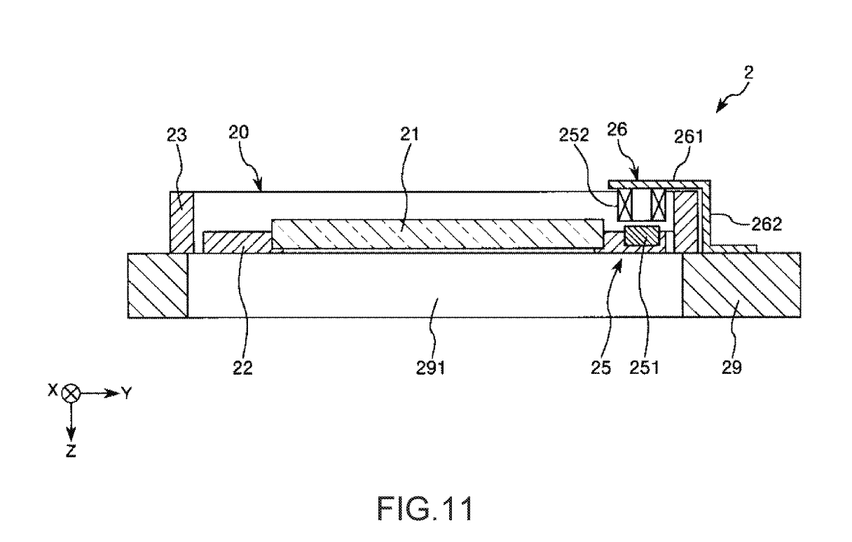

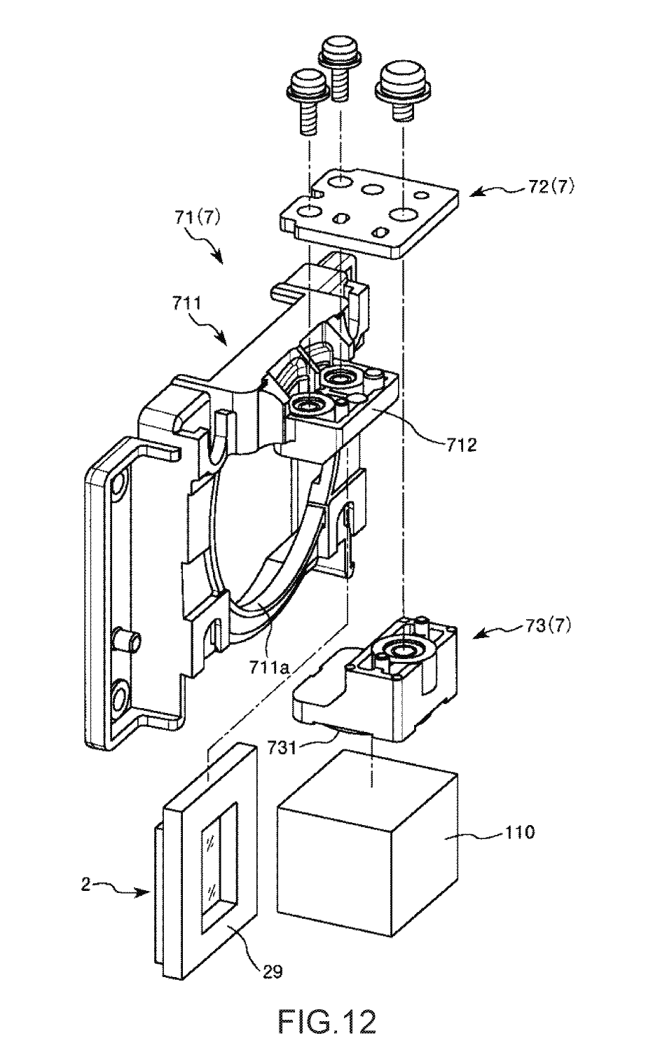

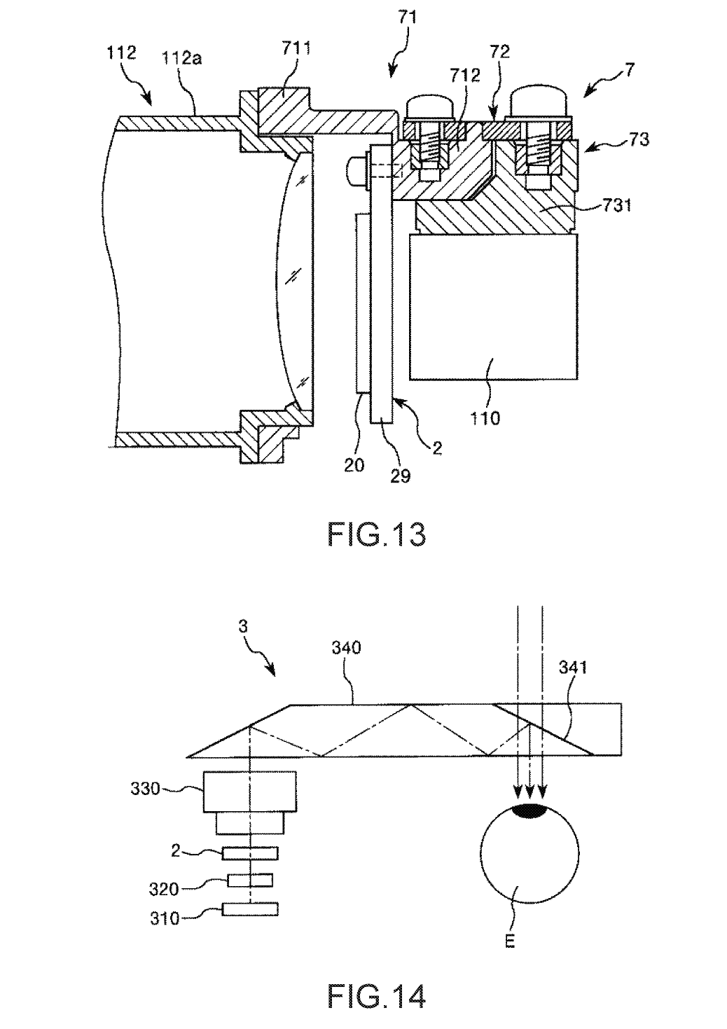

FIG. 10 is a plan view showing an optical device provided in an image display apparatus according to a second embodiment of the invention. FIG. 11 is a cross-sectional view of the optical device shown in FIG. 10. FIG. 12 is a perspective view showing a holding member provided in the image display apparatus. FIG. 13 is a cross-sectional view of the holding member shown in FIG. 12.

The image display apparatus according to the second embodiment of the invention will be described below. The description will be primarily made of points different from those in the embodiment described above, and the same items will not be described.

The image display apparatus according to the second embodiment is the same as the image display apparatus according to the first embodiment described above except that the optical device is configured differently. The same components as those in the embodiment described above have the same reference characters.

The optical device 2 in the present embodiment further includes an enclosure 29, as shown in FIGS. 10 and 11. The enclosure 29 functions, for example, as a reinforcing member that reinforces the structural body 20. The thus intended enclosure 29 has a frame-like shape having an opening 291 provided at the center thereof and is so disposed as not to interfere with the passage of the video image light LL. The enclosure 29 supports the support section 23 and the coil support section 26, and the coil support section 26 is supported by and fixed to the support section 23 via the enclosure 29. In the configuration described above, in which the enclosure 29 is interposed between the coil support section 26 and the support section 23, the heat generated by the coil 252 is more unlikely to be transmitted to the support section 23 via the coil support section 26. Therefore, changes in the vibration characteristics of the optical device 2 that result from thermal expansion of the structural body 20, softened shafts sections 24a and 24b due to the heat, and other factors are suppressed by a greater amount than in the first embodiment described above, whereby more stable vibration characteristics are achieved.

In particular, in the present embodiment, the coil support section 26 is so disposed as to be separate from the structural body 20, as shown in FIG. 11. That is, the coil support section 26 is so provided as not to be in contact with the structural body 20. As a result, heat is more unlikely to be transmitted from the coil support section 26 to the structural body 20, whereby the advantageous effect described above is provided in a more remarkable manner. Further, in the present embodiment, since the second support section 262 is located outside the structural body 20, the cooling air described above is more readily sprayed on the second support section 262.

The material of which the enclosure 29 is made is not limited to a specific material but is preferably not only a material having thermal conductivity higher than that of the support section 23 but also a material that is nonmagnetic, as in the case of the coil support section 26. The heat generated by the coil 252 can thus be dissipated through the coil support section 26 and the enclosure 29, whereby the heat dissipating effect is enhanced. Further, since the enclosure 29 does not form a magnetic path of the magnetic field produced by the coil 252, the magnetic field produced by the coil 252 is allowed to act on the magnet in an efficient manner.

The thus configured enclosure 29 is preferably allowed, for example, to be connected to a holding member for fixing (positioning) the dichroic prism 110, the projection lens system 112, and the optical device 2 with respect to each other. As a result, the enclosure 29 can be effectively used, and the size of the projector 1 can also be reduced. These advantageous effects will be described below by presenting an example.

In the projector 1, the dichroic prism 110, the projection lens system 112, and the optical device 2 are held by a holding member 7 and fixed thereto with the components described above optically aligned with one another, as shown in FIGS. 12 and 13.

The holding member 7 has a first holding member 71, which holds the projection lens system 112 and the optical device 2, a second holding member 72, which is held by the first holding member 71, and a third holding member 73, which is held by the second holding member 72 and holds the dichroic prism 110.

The first holding member 71 has a lens barrel holding section 711, which supports a lens barrel 112a of the projection lens system 112, and a holding section 712, which protrudes from an upper portion of the lens barrel holding section 711 toward the upstream side along the optical path. The lens barrel holding section 711 has a roughly rectangular plate-like shape and has an opening 711a, which is formed of a circular hole and provided at the center of the lens barrel holding section 711, and the lens barrel 112a of the projection lens system 112 is inserted through the opening 711a. The lens barrel 112a inserted through the opening 711a is aligned with and fixed to the lens barrel holding section 711 with screws. On the other hand, the holding section 712 holds the enclosure 29 of the optical device 2, and the optical device 2 is located between the projection lens system 112 and the dichroic prism 110.

The second holding member 72 is disposed above the first holding member 71 and aligned with and fixed to the first holding member 71 with screws.

The third holding member 73 serves as a base member when the dichroic prism 110 is aligned with the projection lens system 112 and holds the dichroic prism 110. Specifically, a fixing section 731 is provided on the lower surface of the third holding member 73, and the upper surface of the dichroic prism 110 is fixed to the fixing section 731, for example, with an adhesive. The thus configured third holding member 73 is disposed below the second holding member 72 and fixed to the second holding member 72 with screws.

The second embodiment described above can also provide the same advantageous effects provided by the first embodiment described above.

### Third Embodiment

FIG. 14 shows an optical configuration of an image display apparatus according to a third embodiment of the invention.

The image display apparatus according to the third embodiment of the invention will be described below. The description will be primarily made of points different from those in the embodiments described above, and the same items will not be described.

The image display apparatus according to the third embodiment is a semitransparent (see-through-type) head mounted display (hereinafter also simply referred to as “HMD”).

An HMD (image display apparatus) 3 according to the present embodiment is mounted on a viewer (user) for use and includes a light source 310, a liquid crystal display element 320, a projection lens system 330, a light guide section 340, and the optical device 2 as an optical path deflector, as shown in FIG. 14. The light source 310 is not limited to a specific light source and can be, for example, an LED backlight. Light emitted from the light source 310 is guided to the liquid crystal display element 320. The liquid crystal display element 320 is a transmissive liquid crystal display element and can be, for example, an HTPS (high-temperature polysilicon) single-plate TFT color liquid crystal panel. The liquid crystal display element 320 modulates the light from the light source 310 to produce video image light. The produced video image light is enlarged by the projection lens system and then incident on the light guide section 340. The light guide section 340 has a plate-like shape, and a half-silvered mirror 341 is further disposed on the downstream side in the light propagation direction in the light guide section 340. The light guided into the light guide section 340 travels while being repeatedly reflected and is guided by the half-silvered mirror 341 to the viewer's pupil E. At the same time, external light passes through the half-silvered mirror 341 and is guided to the viewer's pupil E. The viewer who wears the HMD 3 therefore visually recognizes the video image light with an outside scene superimposed thereon.

In the thus configured HMD 3, the optical device 2 is disposed between the liquid crystal display element 320 and the projection lens system 330 and can shift the optical axis of the video image light LL.

The third embodiment described above can also provide the same advantageous effects provided by the first embodiment described above.

### Fourth Embodiment

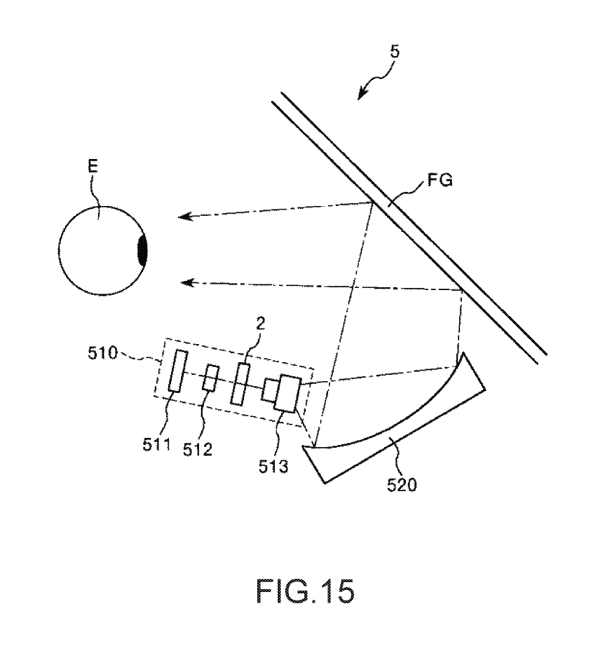

FIG. 15 shows an optical configuration of an image display apparatus according to a fourth embodiment of the invention.

The image display apparatus according to the fourth embodiment of the invention will be described below. The description will be primarily made of points different from those in the embodiments described above, and the same items will not be described.

The image display apparatus according to the fourth embodiment is a head-up display (hereinafter also simply referred to as “HUD”).

An HUD (image display apparatus) 5 according to the present embodiment is, for example, incorporated in an automobile and used to project a variety of types of information (video images), such as the speed per hour, the time, and the travel distance, on a driver via a windshield FG. The HUD 5 includes a projection unit 510 including a projection unit 520 including a light source 511, a liquid crystal display element 512, and a projection lens system 513, a reflection mirror 520, and the optical device 2 as an optical path defector, as shown in FIG. 15. The light source 511, the liquid crystal display element 512, and the projection lens system 513 can be configured, for example, in the same manner as the light source 310, the liquid crystal display element 320, and the projection lens system 330 in the third embodiment described above. The reflection mirror 520 is a concave mirror and reflects projection light from the projection unit 510 to project (display) the projection light on the windshield FG.

In the thus configured HUD 5, the optical device 2 is disposed between the liquid crystal display element 512 and the projection lens system 513 and can shift the optical axis of the projection light.

The fourth embodiment described above can also provide the same advantageous effects provided by the first embodiment described above.

The optical devices and the image display apparatus according to the embodiments of the invention have been described with reference to the drawings, but the invention is not limited to the embodiments. For example, in the optical devices and the image display apparatus according to the embodiments of the invention, the configuration of each portion can be replaced with an arbitrary configuration having the same function, and other arbitrary configurations can be added.

Further, the above embodiments have been described with reference to the optical device in which the optical section has light transmissivity and which is used as a pixel shift device, but the application of the optical device is not limited thereto. For example, the optical device may be used as an optical scanner in which the light incident portion of the optical section has light reflectivity and light reflected off the light incident portion is swept on the basis of swing motion of the movable section.

Further, the above embodiments have been described with reference to a liquid crystal projector and an optical-sweeper-type projector as the image display apparatus, but the image display apparatus is not limited to a projector, and the invention is also applicable to a printer, a scanner, and other apparatus.

The entire disclosure of Japanese Patent Application No. 2015-129589, filed Jun. 29, 2015 is expressly incorporated by reference herein.

What is claimed is:

1. An optical device comprising:
an optical section having a light incident surface on which light is incident;
a movable section that supports the optical section;
a shaft section that swingably supports the movable section around a swing axis;
a support section that supports the shaft section;
a permanent magnet provided in the movable section;
a coil that produces a magnetic field acting on the permanent magnet; and
a coil support section that supports the coil,
wherein the coil support section is made of a material having thermal conductivity higher than thermal conductivity of the support section and intersects an in-plane direction of the light incident surface.

2. The optical device according to claim 1,
wherein the coil support section is disposed along a surface of the coil that is a side surface formed in a direction that intersects the in-plane direction of the light incident surface.

3. The optical device according to claim 2,
wherein the coil has an elongated shape in a plan view in a thickness direction of the optical section, and
the coil support section is disposed along the elongated direction of the coil and along the side surface formed in the direction that intersects the in-plane direction of the light incident surface.

4. The optical device according to claim 1,
wherein the coil support section includes
a first support section that supports the coil and is provided along the in-plane direction of the light incident surface, and
a second support section that intersects the first support section and supports a surface of the coil that is a side surface formed in a direction that intersects the in-plane direction of the light incident surface.

5. The optical device according to claim 4,
wherein the coil is so disposed as to face the permanent magnet, and the coil is so located that a surface thereof facing the permanent magnet is closer than the second support section to the permanent magnet in a plan view in which the second support section is viewed in a direction parallel to the light incident surface.

6. The optical device according to claim 5,
wherein the support section has a window through which a clearance between the permanent magnet and the coil is visible.

7. The optical device according to claim 6,
wherein the window is a through hole.

8. The optical device according to claim 1, further comprising
an enclosure that supports the support section,
wherein the coil support section is supported by the enclosure.

9. The optical device according to claim 8,
wherein the coil support section is so disposed as to be separate from the support section.

10. The optical device according to claim 1,
wherein the optical section transmits the light.

11. An image display apparatus comprising the optical device according to claim 1.

12. An image display apparatus comprising the optical device according to claim 2.

13. An image display apparatus comprising the optical device according to claim 3.

14. An image display apparatus comprising the optical device according to claim 4.

15. An image display apparatus comprising the optical device according to claim 5.

16. An image display apparatus comprising the optical device according to claim 6.

17. An image display apparatus comprising the optical device according to claim 7.

18. An image display apparatus comprising the optical device according to claim 8.

19. An image display apparatus comprising the optical device according to claim 9.

20. The image display apparatus according to claim 11,
wherein the image display apparatus is so configured that the optical device refracts the light to shift positions of pixels displayed when irradiated with the light.
